(19) United States
(12) Patent Application Publication
(10) Pub. No.: US 2024/0118399 A1
(43) Pub. Date: Apr. 11, 2024

(54) IMAGE SENSOR RELATED TO MEASURING DISTANCE

(71) Applicant: SK hynix Inc., Icheon-si Gyeonggi-do (KR)

(72) Inventor: Jae Hyung JANG, Icheon-si Gyeonggi-do (KR)

(73) Assignee: SK hynix Inc., Icheon-si Gyeonggi-do (KR)

(21) Appl. No.: 18/119,216

(22) Filed: Mar. 8, 2023

(30) Foreign Application Priority Data
Oct. 11, 2022 (KR) 10-2022-0129866

(51) Int. Cl. G01S 7/4914; G01S 17/36; G01S 17/894; H04N 25/771; H04N 25/79

(52) U.S. Cl. CPC G01S 7/4914; G01S 17/36; G01S 17/894; H04N 25/771; H04N 25/79

(57) ABSTRACT

An image sensor includes: a unit pixel configured to output pixel data in response to a drive signal being input to the unit pixel; and a control circuit configured to provide the unit pixel with a first drive signal and a second drive signal each having a first phase, and a third drive signal having a second phase with a phase difference of 180 degrees with respect to the first phase in a first mode, the control circuit providing the unit pixel with the first drive signal having the first phase, the second drive signal having the second phase, and the third drive signal having a deactivation voltage in a second mode.

### CROSS-REFERENCE TO RELATED APPLICATION

The present application claims priority under 35 U.S.C. § 119(a) to Korean patent application number 10-2022-0129866 filed on Oct. 11, 2022, in the Korean Intellectual Property Office, the entire disclosure of which is incorporated by reference herein.

### BACKGROUND

### 1. Technical Field

Various embodiments of the present disclosure generally relate to an image sensor, and more particularly, to an image sensor configured to measure a distance from an external object by using a time-of-flight (ToF) technique.

### 2. Related Art

Recently, there has been an increasing demand for an image sensor which measures a distance from an external object in various fields such as security, medical devices, automobiles, video game consoles, VR/AR, and mobile devices. Distance measurement techniques may include triangulation, time-of-flight (hereinafter, “ToF”), interferometry, and the like. The ToF technique is a method of calculating the distance by measuring a time of flight by light or a signal, i.e., the time taken by light or a signal to reflect off an object after being output. The ToF may have a wide range of usage, fast processing speed, and cost efficiency. According to indirect ToF, modulated light wave (hereinafter, ‘modulated light’) may be emitted through a light source. The modulated light may include a sine wave, a pulse train, or another periodical waveform. A ToF sensor may detect reflected light in which the modulated light reflects off a surface in an observed scene. An electronic device may measure a phase difference between the emitted modulated light and the received reflected light and calculate a physical distance between the ToF sensor and an external object in the scene.

### SUMMARY

According to an embodiment, an image sensor may include a unit pixel configured to output a pixel data in response to a drive signal being input to the unit pixel, and a control circuit configured to provide the unit pixel with a first drive signal and a second drive signal each having a first phase, and a third drive signal having a second phase with a phase difference of 180 degrees with respect to the first phase in a first mode, the control circuit providing the unit pixel with the first drive signal having the first phase, the second drive signal having the second phase, and the third drive signal having a deactivation voltage in a second mode.

According to an embodiment, an electronic device may include a light source configured to output modulated light corresponding to a first phase, a unit pixel including a photoelectric conversion region configured to generate photocharges in a substrate from reflected light in which the modulated light is reflected by an external object, and a first tap, a second tap, and a third tap configured to generate a pixel current in the substrate and capture the photocharges moved by the pixel current, a control circuit configured to control the first to third taps to generate the pixel current by applying a first drive signal, a second drive signal, and a third drive signal to the first tap, the second tap, and the third tap, respectively, and a distance measuring module configured to identify a distance from the external object on the basis of pixel data corresponding to the photocharges captured and received from at least part of the first tap, the second tap, and the third tap, wherein in the first mode, each of the first drive signal and the second drive signal has the first phase, and the third drive signal has a second phase with a phase difference of 180 degrees with respect to the first phase, and in the second mode, the first drive signal has the first phase, the second drive signal has the second phase, and the third drive signal has a deactivation voltage.

According to an embodiment, a method of operating an electronic device may include outputting modulated light corresponding to a first phase through a light source, generating photocharges in a substrate on the basis of reflected light in which the modulated light is reflected by an external object through a photoelectric conversion region included in a unit pixel, generating a pixel current in the substrate and capturing the photocharges moved by the pixel current through at least one of a first tap, a second tap, and a third tap included in the unit pixel by applying a first drive signal, a second drive signal, and a third drive signal to the first tap, the second tap, and the third tap, respectively, according to one of a first mode and a second mode, and identifying a distance from the external object on the basis of pixel data corresponding to the photocharges captured by the at least one of the first tap, the second tap, and the third tap, wherein in the first mode, each of the first drive signal and the second drive signal has the first phase, and the third drive signal has a second phase with a phase difference of 180 degrees with respect to the first phase, and in the second mode, the first drive signal has the first phase, the second drive signal has the second phase, and the third drive signal has a deactivation voltage.

### BRIEF DESCRIPTION OF THE DRAWINGS

FIG. 1 is a diagram illustrating a configuration of an electronic device according to an embodiment of the present disclosure;

FIG. 2 is a diagram illustrating an example of a unit pixel according to an embodiment of the present disclosure;

FIG. 3 is a diagram illustrating an example of a unit pixel according to an embodiment of the present disclosure;

FIG. 4 is a diagram illustrating how a unit pixel is coupled to a control circuit according to an embodiment of the present disclosure;

FIG. 5 is a diagram illustrating how a unit pixel is coupled to a readout circuit according to an embodiment of the present disclosure;

FIG. 6 is a diagram illustrating drive signals applied to taps in a first mode according to an embodiment of the present disclosure;

FIG. 7 is a diagram illustrating movements of photocharges in a unit pixel driven in a first mode according to an embodiment of the present disclosure;

FIG. 8 is a diagram illustrating drive signals applied to taps in a first mode according to an embodiment of the present disclosure;

FIG. 9 is a diagram illustrating movements of photocharges in a unit pixel driven in a second mode according to an embodiment of the present disclosure;

FIG. 10 is a diagram illustrating a method of measuring a distance from an external object by a distance measuring module according to an embodiment of the present disclosure;

FIG. 11 is a flow chart illustrating a method of identifying a distance from an external object on the basis of drive signals applied to three taps, respectively, by an electronic device;

FIG. 12 is a diagram illustrating an example of circuit configurations of first, second, and third taps according to an embodiment of the present disclosure;

FIG. 13 is a diagram illustrating an example of signals provided to a unit pixel in a first mode according to an embodiment of the present disclosure;

FIG. 14 is a diagram illustrating an example of signals provided to a unit pixel in a second mode according to an embodiment of the present disclosure;

FIG. 15 is a diagram illustrating another example of circuit configurations of first, second, and third taps according to an embodiment of the present disclosure;

FIG. 16 is a diagram illustrating another example of signals provided to a unit pixel in a first mode according to an embodiment of the present disclosure;

FIG. 17 is a diagram illustrating another example of signals provided to a unit pixel in a second mode according to an embodiment of the present disclosure;

FIG. 18 is a diagram illustrating another example of circuit configurations of first, second, and third taps according to an embodiment of the present disclosure;

FIG. 19 is a diagram illustrating another example of signals provided to a unit pixel in a first mode according to an embodiment of the present disclosure; and

FIG. 20 is a diagram illustrating another example of signals provided to a unit pixel in a second mode according to an embodiment of the present disclosure.

### DETAILED DESCRIPTION

Specific structural or functional descriptions of examples of embodiments in accordance with concepts which are disclosed in this specification are illustrated only to describe the examples of embodiments in accordance with the concepts and the examples of embodiments in accordance with the concepts may be carried out by various forms but the descriptions are not limited to the examples of embodiments described in this specification.

Hereinafter, embodiments of the present disclosure will be described in detail with reference to the accompanying drawings in order for those skilled in the art to be able to readily implement the technical spirit of the present disclosure.

First though, a ToF sensor measures a distance from an external object, based on reflected light in which modulated light is reflected by the external object. However, the ToF sensor may be easily saturated in environment with more light, such as ambient light, other than the modulated light, thereby degrading distance measurement performance. Since a ToF sensor with full well capacity which is not easily saturated even in a high-light environment has a small conversion gain, noise characteristics in a low-light environment may be deteriorated. As a result, distance measurement performance may be degraded.

An embodiment of the present disclosure provides a ToF sensor capable of flexibly controlling full well capacity according to brightness of surrounding environment.

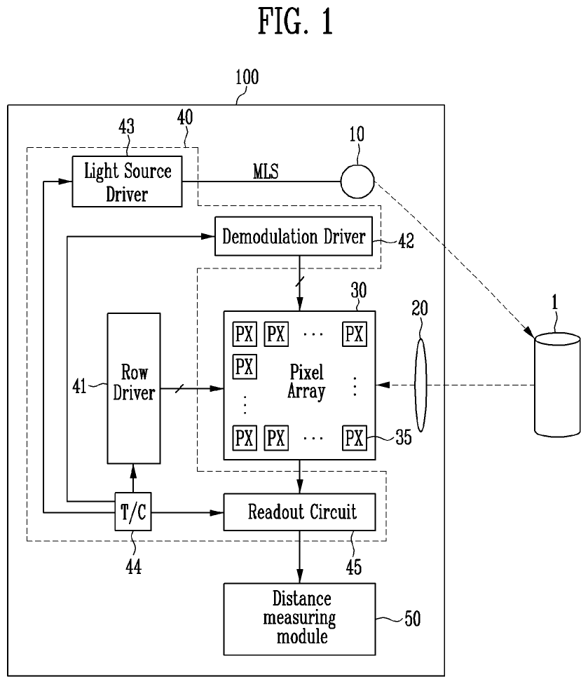

FIG. 1 is a diagram illustrating a configuration of an electronic device 100 according to an embodiment of the present disclosure.

Referring to FIG. 1, the electronic device 100 may measure a distance from an external object 1 by using a time of flight (ToF) method. According to the ToF method, modulated light may be emitted to the external object 1, reflected light which is reflected by the external object 1 and is incident, and the distance between the electronic device 100 and the external object 1 may be directly measured based on a phase difference between the modulated light and the reflected light.

Referring to FIG. 1, the electronic device 100 may include a light source 10, a lens module 20, a pixel array 30, a control block 40, and a distance measuring module 50.

The light source 10 may emit light to the external object 1 in response to a modulated optical signal MLS which is provided from the control block 40. The light source 10 may be a laser diode LD which emits light in a specific wavelength band (e.g., near-infrared, infrared, or visible light), a light emitting diode (LED), a near infrared laser (NIR), a point light source, a monochromatic light source with a combination of a white light lamp and a monochromator, or a combination of other laser light sources. For example, the light source 10 may emit infrared light having a wavelength ranging from 800 nm to 1000 nm. Light which is emitted by the light source 10 may be modulated light which is modulated at a predetermined frequency. In other words, the light source 10 may output modulated light corresponding to a first phase. In the first phase, an activation voltage and a deactivation voltage may be repeated at a predetermined cycle. For convenience of explanation, FIG. 1 describes one light source 10. However, a plurality of light sources may be arranged around the lens module 20.

The lens module 20 may collect light reflected from the external object 1 and concentrate it on the unit pixels 35 of the pixel array 30. The lens module 20 may include a focusing lens of a glass or plastic surface, or another cylindrical optical element. The lens module 20 may include a plurality of lenses which are aligned on the basis of an optical axis.

The pixel array 30 may include a plurality of unit pixels 35 which are arranged continuously in a two-dimensional matrix format. For example, the pixel array 30 may include the unit pixels 35 which are arranged continuously in a row direction and a column direction. The unit pixel 35 may refer to a smallest unit in which the same pattern is repeated over the pixel array 30.

Each of the unit pixels 35 may be formed on a semiconductor substrate. Each unit pixel 35 may output a pixel signal by converting light received through the lens module 20 into an electric signal corresponding to the intensity of the light. The pixel signal may be used to measure the distance between the electronic device 100 and the external object 1.

Each unit pixel 35 may be a current-assisted photonic demodulator (CAPD) pixel and capture photoelectrons generated in the substrate by incident light by using a potential difference of an electric field. The structure and operation of each unit pixel 35 will be described below in more detail.

The control block 40 may include a row driver 41, a demodulation driver 42, a light source driver 43, a timing controller (T/C) 44, and a readout circuit 45. In the present disclosure, the row driver 41 and the demodulation driver 42 may be collectively referred to as a control circuit.

The control circuit (e.g., the row driver 41 and the demodulation driver 42) may drive the unit pixels 35 of the pixel array 30 in response to a timing signal which is output from the timing controller 44.

The control circuit (e.g., the row driver 41) may generate a control signal for selecting and controlling at least one row line among the plurality of row lines of the pixel array 30. The control signal may include at least one of a reset signal for controlling a reset transistor, a transfer signal for controlling transfer of photocharges accumulated in a detection area, a floating diffusion signal for providing additional capacitance under high illumination conditions, and a select signal for controlling the select transistor.

The control circuit (e.g., the demodulation driver 42) may generate and output a drive signal for generating a pixel current in substrates of the unit pixels 35. The pixel current may refer to a current which causes photocharges generated in the substrates to the detection area (e.g., a tap).

FIG. 1 illustrates that the row driver 41 and the demodulation driver 42 are independent components. However, this is an example. The row driver 41 and the demodulation driver 42 may be configured as a single component and disposed at one side of the pixel array 30.

The light source driver 43 may generate the modulated optical signal MLS for driving the light source 10 in response to control of the timing controller 44. The modulated optical signal MLS may refer to a signal which is modulated at a specified frequency. The word “specified” as used herein with respect to a parameter, such as a predetermined frequency, predetermined voltage, predetermined value, predetermined cycle, and predetermined phase difference, means that a value for the parameter is determined prior to the parameter being used in a process or algorithm. For some embodiments, the value for the parameter is determined before the process or algorithm begins. In other embodiments, the value for the parameter is determined during the process or algorithm but before the parameter is used in the process or algorithm.

The timing controller 44 may generate a timing signal for controlling operations of the row driver 41, the demodulation driver 42, the light source driver 43, and the readout circuit 45.

The timing controller 44 may control the readout circuit 45 to generate pixel data in the form of a digital signal by processing pixel signals which are output from the pixel array 30. For example, the readout circuit 45 may perform correlated double sampling (CDS) on the pixel signals which are output from the pixel array 30. The electronic device 100 may reduce readout noise which is included in the pixel signals through the CDS. In addition, the readout circuit 45 may include an analog-digital converter (ADC) for converting the output signals subject to the CDS into digital signals. In addition, the readout circuit 45 may include a buffer circuit which stores pixel data which is output by the ADC. The timing controller 44 may control the buffer circuit to output the pixel data to the outside.

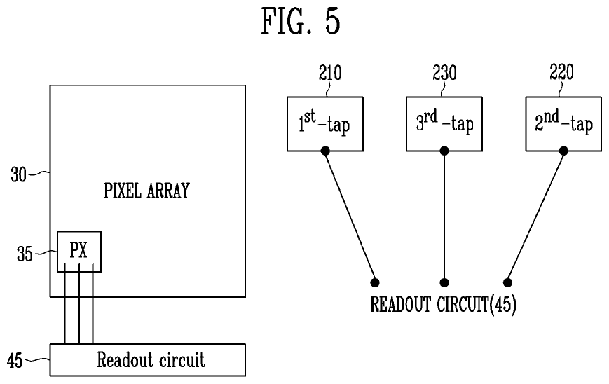

Each one of the columns of the pixel array 30 may include at least one column line for transferring a pixel signal to the readout circuit 45. Configurations for processing a pixel signal which is output from each of the column lines may be provided corresponding to each column line. The column line will be described below with reference to FIG. 5.

The distance measuring module 50 may receive the pixel data from the readout circuit 45 and identify a distance (or depth) from the external object 1 on the basis of the pixel data. For example, when the light source 10 emits modulated light, which is modulated at a specified frequency in advance, toward a scene being taken by the electronic device 100, and the electronic device 100 detects reflected light (or incident light) which reflects from the external object 1 in the scene, a time delay may exist between the modulated light and the reflected light, depending on the distance between the electronic device 100 and the external object 1. When a phase difference of the modulated light corresponds to a first phase, the phase of the reflected light may correspond to a third phase which has a specified phase difference from the first phase. The distance measuring module 50 may identify a third phase corresponding to the reflected light on the basis of the pixel data. In addition, the distance measuring module 50 may identify the distance from the external object 1 on the basis of the phase difference between the first phase and the third phase. The electronic device 100 may generate a depth image which includes depth information of each unit pixel 35 by using the phase difference between the modulated light and the reflected light.

FIG. 1 does not separately illustrate an image sensor. However, the pixel array 30, the row driver 41, the demodulation driver 42, and the readout circuit 45 as shown in FIG. 1 may be understood as being included in the image sensor.

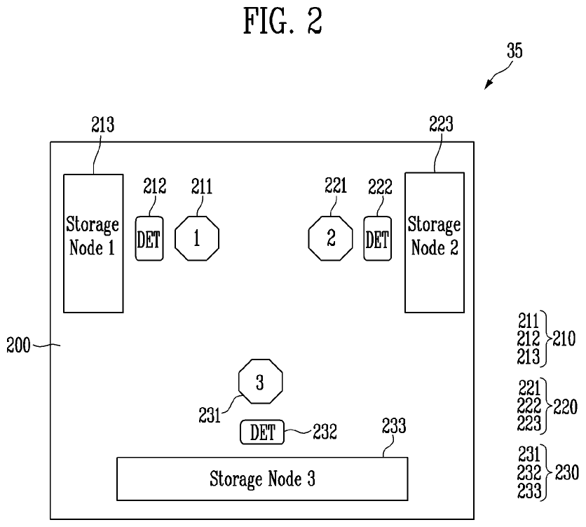

FIG. 2 is a diagram illustrating an example of the unit pixel 35 according to an embodiment of the present disclosure. The unit pixel 35 as shown in FIG. 2 may be one of the unit pixels 35 shown in FIG. 1. For convenience of explanation, FIG. 2 exemplifies any one of the unit pixels 35. However, any unit pixel included in the pixel array 30 may also have substantially the same structure.

Referring to FIG. 2, the unit pixel 35 may include a photoelectric conversion region 200. According to an embodiment shown in FIG. 2, the photoelectric conversion region 200 may be a substrate. The photoelectric conversion region 200 may generate photocharges in the substrate from incident light being incident on the unit pixel 35. For example, when light is incident on the unit pixel 35, a photon may be generated in the photoelectric conversion region 200.

Referring to FIG. 2, the unit pixel 35 may include a first tap 210, a second tap 220, and a third tap 230. The first tap 210, the second tap 220, and the third tap 230 of the unit pixel 35 may be formed in the substrate. In other words, in the present disclosure, the unit pixel 35 may include the three taps (210, 220, and 230). In the present disclosure, a tap may refer to a node which generates a pixel current in a substrate as a modulation voltage is applied. The tap may be referred to as a demodulation node.

The first tap 210 may include a first control node 211, a first detection node 212, and a first storage node 213. As shown in FIG. 2, the first detection node 212 may be located between the first control node 211 and the first storage node 213. However, this is only for convenience of explanation. The shape of the first detection node 212 is not limited thereto. For example, the first detection node 212 may be shaped to surround the first control node 211 in the substrate.

The second tap 220 may include a second control node 221, a second detection node 222, and a second storage node 223. The third tap 230 may include a third control node 231, a third detection node 232, and a third storage node 233. The description about the shape of the first detection node 212 as described above may also be applicable to the second detection node 222 and the third detection node 232.

The control circuit (e.g., the demodulation driver 42 of FIG. 1) may apply a first drive signal to the first control node 211, a second drive signal to the second control node 221, and a third drive signal to the third control node 231. According to an embodiment, each of the first drive signal, the second drive signal, and the third drive signal may correspond to a modulation voltage. For example, in a first mode, a modulated voltage may be applied to the first control node 211, the second control node 221, and the third control node 231. The electronic device 100 (or an image sensor) may generate a pixel current in the substrate of the unit pixel 35 by applying the modulated voltage to each of the first control node 211, the second control node 221, and the third control node 231. According to another embodiment, some of the first drive signal, the second drive signal, and the third drive signal may correspond to a specified voltage. For example, in a second mode, a deactivation voltage (e.g., 0 V) may be applied to the third control node 231. The electronic device 100 (or an image sensor) may generate a pixel current in the substrate of the unit pixel 35 by applying the modulated voltage to the first control node 211 and the second control node 221, and applying the deactivation voltage to the third control node 231 by the control circuit.

The electronic device 100 (or the image sensor) may move photocharges generated in the photoelectric conversion region 200 by generating a pixel current in the substrate of the unit pixel 35. The moved photocharges may be captured by at least one of the first detection node 212, the second detection node 222, and the third detection node 232. In other words, the electronic device 100 (or the image sensor) may capture photocharges (e.g. photons) generated in the substrate by incident light through at least one of the first tap 210, the second tap 220, and the third tap 230.

The photocharges which are captured by at least one of the first tap 210, the second tap 220, and the third tap 230 may be stored in at least one storage node among the first storage node 213, the second storage node 223, and the third storage node 233. For example, the photocharges captured by the first detection node 212 may be stored in the first storage node 213. The photocharges captured by the second detection node 222 may be stored in the second storage node 223. The photocharges captured by the third detection node 232 may be stored in the third storage node 233.

According to the present disclosure, the capacity of the first tap 210 may correspond to that of the second tap 220. In addition, the capacity of the third tap 230 may correspond to the sum of the capacity of the first tap 210 and the capacity of the second tap 220. In other words, the capacity of the first tap 210, the capacity of the second tap 220, and the capacity of the third tap 230 may be 1:1:2. A capacity of a tap may refer to a storage capacity of the tap which includes at least some of the capacities of the storage nodes 213, 223, and 233, the capacity of a floating diffusion node of each tap, and the capacity of an FD capacitor.

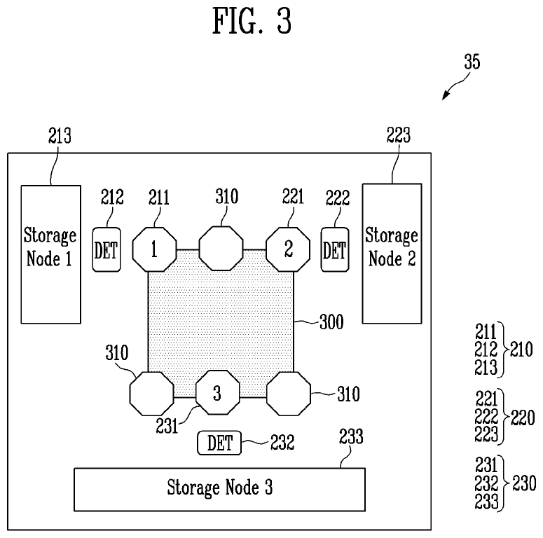

FIG. 3 is a diagram illustrating another example of the unit pixel 35 according to an embodiment of the present disclosure. The unit pixel 35 as shown in FIG. 3 may be one of the unit pixels 35 shown in FIG. 1. For convenience of explanation, FIG. 3 exemplifies any one of the unit pixels 35. However, any unit pixel included in the pixel array 30 may have substantially the same structure.

Referring to FIG. 3, the unit pixel 35 may include a photoelectric conversion region 300. According to an embodiment shown in FIG. 3, the photoelectric conversion region 300 may be a photodiode. In other words, while in the embodiment of FIG. 2, the photoelectric conversion region 200 is a substrate, the photoelectric conversion region 300 of FIG. 3 may be a photodiode. Various other configurations which are capable of converting incident light into an electric signal may be used as the photoelectric conversion region 300.

Referring to FIG. 3, the unit pixel 35 may include the first tap 210, the second tap 220, and the third tap 230. The descriptions about the first tap 210, the second tap 220, and the third tap 230 as shown in FIG. 2 may be applicable to the first tap 210, the second tap 220, and the third tap 230 shown in FIG. 3. In other words, the electronic device 100 (or the image sensor) may generate a pixel current in the substrate by applying a first drive signal, a second drive signal, and a third drive signal to the first control node 211, the second control node 221, and the third control node 231, respectively, by the control circuit. In addition, the electronic device 100 may capture photocharges, which are generated by the photodiode and moved by the pixel current, through at least one of the first detection node 212, the second detection node 222, and the third detection node 232. The captured photocharges may be stored in at least one of the first storage node 213, the second storage node 223, and the third storage node 233.

Referring to FIG. 3, the unit pixel 35 may further include an overflow gate 310. The overflow gate 310 may prevent or mitigate the photocharges generated in the photoelectric conversion region 300 (e.g., a photodiode) from overflowing into another region.

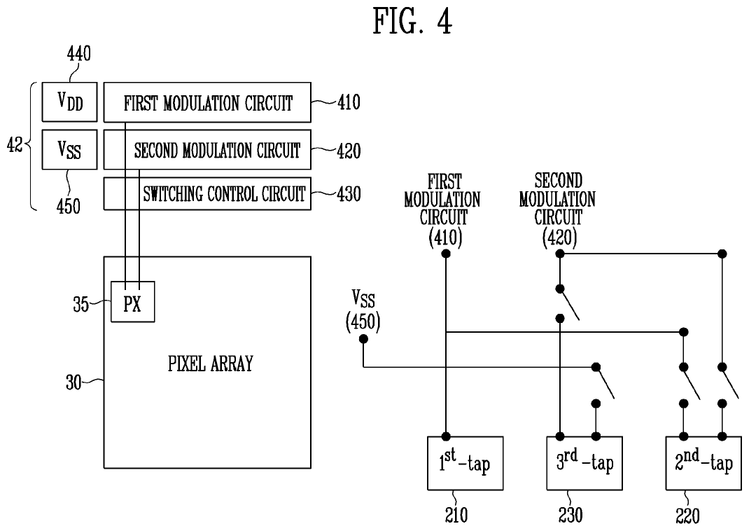

Referring to FIGS. 1, 2, and 3, the unit pixel 35 according to the present disclosure may include the three taps, i.e., 210, 220, and 230, and the electronic device 100 may measure the distance from the external object 1 (or the depth of the external object 1) by a ToF method using at least one of the three taps per unit pixel 35. The electronic device 100 of the present disclosure may drive the image sensor in a first mode or a second mode according to ambient brightness of the electronic device 100. For example, the electronic device 100 (or a processor included in the electronic device) may drive the image sensor in the first mode in response to the ambient luminance of the electronic device 100 when it is determined to be equal to or greater than a threshold value. On the other hand, the electronic device 100 may drive the image sensor in the second mode in response to the ambient luminance when it is determined to be less than the threshold value. In the first mode, the electronic device 100 may measure the distance from the external object 1 by using the first tap 210, the second tap 220, and the third tap 230. In the second mode, the electronic device 100 may measure the distance from the external object 1 by using the first tap 210 and the second tap 220. The first and second modes will be described below in more detail with reference to FIG. 4 and subsequent drawings.

FIG. 4 is a diagram illustrating how a unit pixel is coupled to a control circuit according to an embodiment of the present disclosure.

The control circuit (e.g., the demodulation driver 42) may provide a drive signal to the unit pixels 35 included in the pixel array 30. For example, the control circuit (e.g., the demodulation driver 42) may apply a first drive signal, a second drive signal, and a third drive signal to the first tap 210, the second tap 220, and the third tap 230 which are included in the unit pixel 35. FIG. 4 illustrates an example of a drive signal line which is used by the control circuit to apply a drive signal to the unit pixel 35.

Referring to FIG. 4, the demodulation driver 42 may include a first modulation circuit 410, a second modulation circuit 420, a switching control circuit 430, V_{DD} 440, and V_{SS} 450. In FIG. 4, V_{DD} 440 may represent a high potential power supply and V_{SS} 450 may represent a low potential power supply.

The first modulation circuit 410 may generate a first modulation voltage which is modulated to have a first phase. For example, the first modulation circuit 410 may generate the first modulation voltage which is modulated such that an activation voltage and a deactivation voltage are repeated at a specified cycle. For example, the activation voltage may be 1.2 V and the deactivation voltage may be 0 V.

The second modulation circuit 420 may generate a second modulation voltage which is demodulated to have a second phase which has a phase difference of 180 degrees with respect to the first phase. For example, the second modulation circuit 420 may generate the second modulation voltage in which the activation voltage and the deactivation voltage are repeated at the specified cycle, and the second modulation voltage may have a phase difference of 180 degrees with the first modulation voltage. In the present disclosure, the phase of the first modulation voltage may be referred to as the first phase, and the phase of the second modulation voltage may be referred to as the second phase.

The switching control circuit 430 may control switches so that the modulation voltages generated by the first modulation circuit 410 and the second modulation circuit 420 may be applied to the first tap 210, the second tap 220, and the third tap 230.

For example, in the first mode, the control circuit (e.g., the demodulation driver 42) may apply the first modulation voltage, which is generated by the first modulation circuit 410, to the first tap 210 and the second tap 220, and may apply the second modulation voltage, which is generated by the second modulation circuit 420, to the third tap 230. The switching control circuit 430 may apply the first modulation voltage, which is generated by the first modulation circuit 410, to the first tap 210 and the second tap 220, and may apply the second modulation voltage, which is generated by the second modulation circuit 420, to the third tap 230.

In another example, in the second mode, the control circuit (e.g., the demodulation driver 42) may apply the first modulation voltage, which is generated by the first modulation circuit 410, to the first tap 210, and may apply the second modulation voltage, which is generated by the second modulation circuit 420, to the second tap 220. In the second mode, the control circuit may apply the V_{SS} 450 to the third tap 230. Alternatively, in the second mode, the control circuit may apply the deactivation voltage to the third tap 230. The switching control circuit 430 may apply the first modulation voltage, which is generated by the first modulation circuit 410, to the first tap 210, may apply the second modulation voltage, which is generated by the second modulation circuit 420, to the second tap 220, and may apply the V_{SS} 450 to the third tap 230.

As shown in FIG. 4, the demodulation driver 42 may be coupled to each unit pixel 35 through two drive signal lines. However, the representation of the drive signal lines shown in FIG. 4 is a mere example. There may be various other embodiments. For example, the demodulation driver 42 may be coupled to each unit pixel 35 through three drive signal lines which are coupled to the first tap 210, the second tap 220, and the third tap 230, respectively.

FIG. 5 is a diagram illustrating how the unit pixel 35 is coupled to the readout circuit 45 according to an embodiment of the present disclosure.

The unit pixels 35 included in the pixel array 30 may be read out by the readout circuit 45. The readout circuit 45 may obtain pixel data corresponding to photocharges captured by at least some of the first tap 210, the second tap 220, and the third tap 230 which are included in the unit pixel 35. FIG. 5 illustrates an example of a column line which is used when the readout circuit 45 reads out the unit pixel 35.

Referring to FIG. 5, the readout circuit 45 may be coupled to each unit pixel 35 through three column lines. The readout circuit 45 may read out the first tap 210, the second tap 220, and the third tap 230 through the column lines which are coupled to the first tap 210, the second tap 220, and the third tap 230, respectively.

For example, in the first mode, the readout circuit 45 may receive a pixel signal corresponding to photocharges which are captured by the first tap 210 through the column line coupled to the first tap 210, may receive a pixel signal corresponding to the photocharges captured by the second tap 220 through the column line coupled to the second tap 220, and may receive a pixel signal corresponding to the photocharges captured by the third tap 230 through the column line coupled to the third tap 230. The readout circuit 45 may perform ADC on the pixel signals which are received from the first tap 210, the second tap 220, and the third tap 230, to thereby generate pixel data in the form of a digital signal.

In another example, in the second mode, the readout circuit 45 may receive a pixel signal corresponding to the photocharges captured by the first tap 210 through the column line coupled to the first tap 210, and may receive a pixel signal corresponding to the photocharges captured by the second tap 220 through the column line coupled to the second tap 220. In the second mode, however, there may be few or no photocharges captured by the third tap 230. Therefore, the readout circuit 45 might not read out the third tap 230. However, the present disclosure is not limited thereto. In the second mode, the readout circuit 45 may read out the third tap 230 through the column line coupled to the third tap 230.

As shown in FIG. 5, the readout circuit 45 may be coupled to each unit pixel 35 through three column lines. However, this is a mere example, and there may be various other embodiments. For example, the first tap 210, the second tap 220, and the third tap 230 may be coupled to the readout circuit 45 through one column line, and the readout circuit 45 may sequentially read out the first tap 210, the second tap 220, and the third tap 230 according to time.

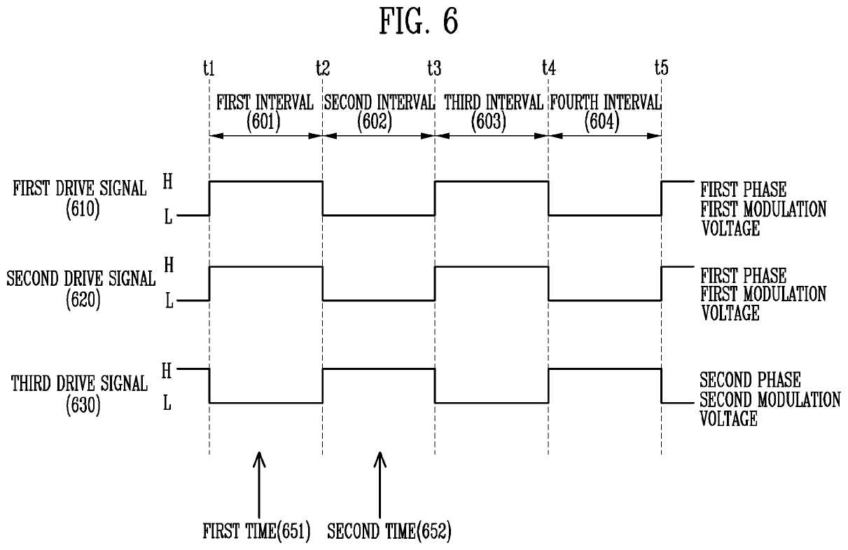

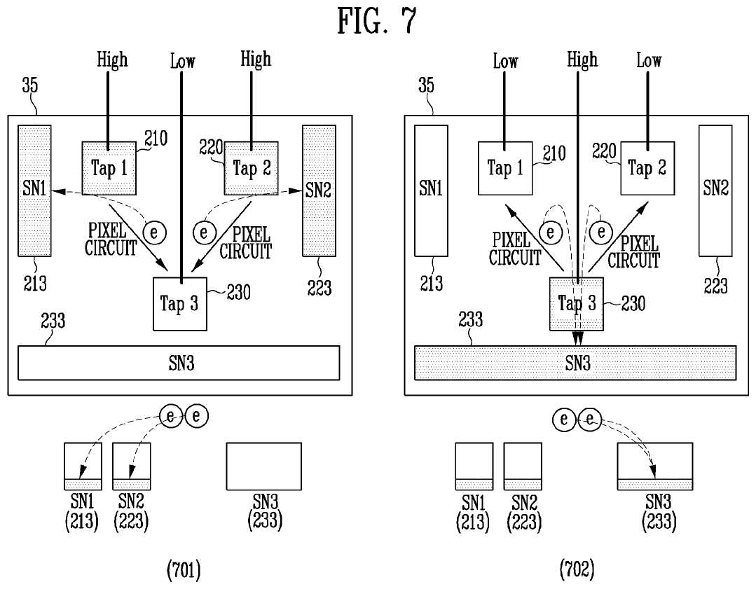

FIG. 6 is a diagram illustrating drive signals applied to taps in a first mode according to an embodiment of the present disclosure. FIG. 7 is a diagram illustrating movements of photocharges in a unit pixel driven in a first mode according to an embodiment of the present disclosure. In FIG. 7, e may represent photocharge. As described above, the first mode may refer to a drive mode of an image sensor when the electronic device 100 is in bright surroundings. The bright surroundings may mean an environment in which light incident on the electronic device is more than a threshold value.

Referring to FIG. 6, the electronic device 100 may apply a first drive signal 610 to the first tap 210, may apply a second drive signal 620 to the second tap 220, and may apply a third drive signal 630 to the third tap 230 by the control circuit. In the present disclosure, the first drive signal 610, the second drive signal 620, and the third drive signal 630 may refer to drive signals which are applied to the first tap 210, the second tap 220, and the third tap 230, respectively.

In the first mode, the first drive signal 610 and the second drive signal 620 may be a first modulation voltage which has a first phase, and the third drive signal 630 may be a second modulation voltage which has a second phase. The first and second phases may have a phase difference of 180 degrees with respect to each other.

In the first phase, an activation voltage H and a deactivation voltage L may be repeated at a specified cycle. For example, the first modulation voltage which has the first phase may have the activation voltage H during a first interval 601 and a third interval 603 and may have the deactivation voltage L during a second interval 602 and a fourth interval 604. The above specified cycle may correspond to a time interval obtained by adding the first interval 601 and the second interval 602, i.e., a time interval from a time t1 to a time t3. In the present disclosure, the phase of the first modulation voltage may be referred to as the first phase.

The second phase may have a phase difference of 180 degrees with respect to the first phase. For example, the second modulation voltage which has the second phase may have the deactivation voltage L during the first interval 601 and the third interval 603 and may have the activation voltage H during the second interval 602 and the fourth interval 604. In the present disclosure, the phase of the second modulation voltage may be referred to as the second phase.

In the first mode, the first drive signal 610 applied to the first tap 210 and the second drive signal 620 applied to the second tap 220 may correspond to the first modulation voltage which has the first phase. In addition, in the first mode, the third drive signal 630 which is applied to the third tap 230 may be the second modulation voltage which has the second phase.

Referring to FIGS. 6 and 7, reference numerals 701 of FIG. 7 show photocharges which are moved within the unit pixel 35 at a first time 651 of FIG. 6, and reference numerals 702 of FIG. 7 may show photocharges which are moved within the unit pixel 35 at a second time 652 of FIG. 6. Referring to FIG. 6, the first time 651 may refer to an arbitrary time at which the first drive signal 610 and the second drive signal 620 have the activation voltage H, and the third drive signal 630 has the deactivation voltage L. In addition, the second time 652 may refer to an arbitrary time at which the first drive signal 610 and the second drive signal 620 have the deactivation voltage L, and the third drive signal 630 has the activation voltage H.

Referring to FIG. 7, as shown by reference numerals 701 corresponding to the first time 651, the activation voltage may be applied to the first tap 210 and the second tap 220, and the deactivation voltage may be applied to the third tap 230. The activation voltage may be referred to as a high level and the deactivation voltage may be referred to as a low level.

A pixel current may be generated in the unit pixel 35 by the voltages which are applied to the first tap 210, the second tap 220, and the third tap 230. As shown by reference numerals 701, the pixel current may be generated in a direction from the first tap 210 toward the third tap 230, and a direction from the second tap 220 toward the third tap 230.

The photocharges may be moved by the pixel current which is generated in the substrate of the unit pixel 35. The photocharges which are generated in the unit pixel 35 by reflected light (or incident light) may be moved by the pixel current. As shown by reference numerals 701, the photocharges may be moved in the direction toward the first tap 210 and the second tap 220 by the pixel current which is generated in the direction from the first tap 210 toward the third tap 230 and the direction from the second tap 220 toward the third tap 230. The photocharges may be captured by the first tap 210 and the second tap 220.

The photocharges which are captured by the first tap 210 and the second tap 220 may be stored in the first storage node 213 and the second storage node 223. As shown in FIG. 7, the first tap 210 may be separated from the first storage node 213, the second tap 220 may be separated from the second storage node 223, and the third tap 230 may be separated from the third storage node 233. However, this is for convenience of explanation. As described above with reference to FIG. 2 or 3, the actual structure of each of the storage nodes 213, 223, and 233 may be understood as being included in each of the taps 210, 220, and 230.

Referring to FIG. 7, as shown by reference numerals 702 corresponding to the second time 652, the deactivation voltage may be applied to the first tap 210 and the second tap 220, and the activation voltage may be applied to the third tap 230.

A pixel current may be generated in the unit pixel 35 by the voltages which are applied to the first tap 210, the second tap 220, and the third tap 230. As shown by reference numerals 702, the pixel current may be generated in a direction from the third tap 230 toward the first tap 210, and a direction from the third tap 230 toward the second tap 220.

The photocharges may be moved by the pixel current which is generated in the substrate of the unit pixel 35. The photocharges which are generated in the unit pixel 35 by reflected light (or incident light) may be moved by the pixel current. As shown by reference numerals 702, the photocharges may be moved in the direction toward the third tap 230 by the pixel current which is generated in the direction from the third tap 230 toward the first tap 210 and the direction from the third tap 230 toward the second tap 220. The photocharges may be captured by the third tap 230. The photocharges captured by the third tap 230 may be stored in the third storage node 233.

According to an embodiment of the present disclosure, the capacity of the third tap 230 may correspond to the sum of the capacity of the first tap 210 and the capacity of the second tap 220. For example, the capacity of the third storage node 233 may correspond to the sum of the capacity of the first storage node 213 and the capacity of the second storage node 223. Therefore, the capacity of the tap which captures and stores the photocharges as shown by reference numerals 701 may be substantially the same as the capacity of the tap which captures and stores the photocharges as shown by reference numerals 702.

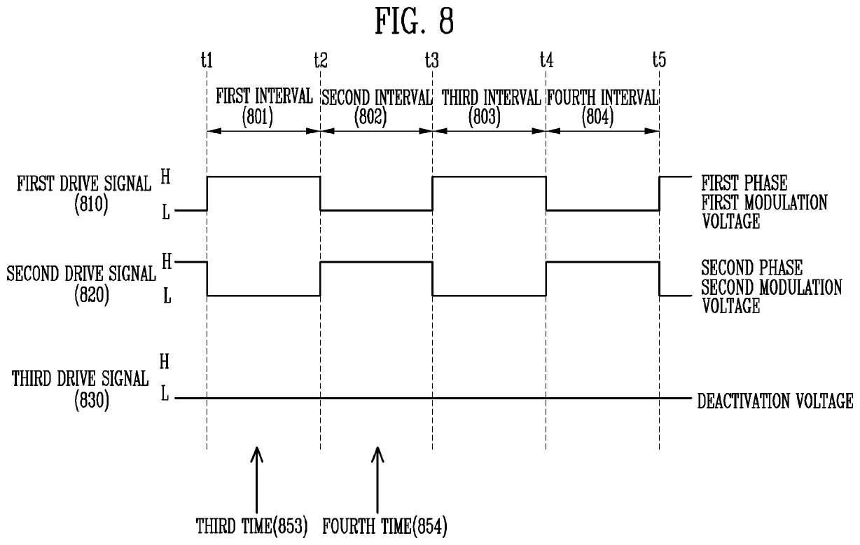

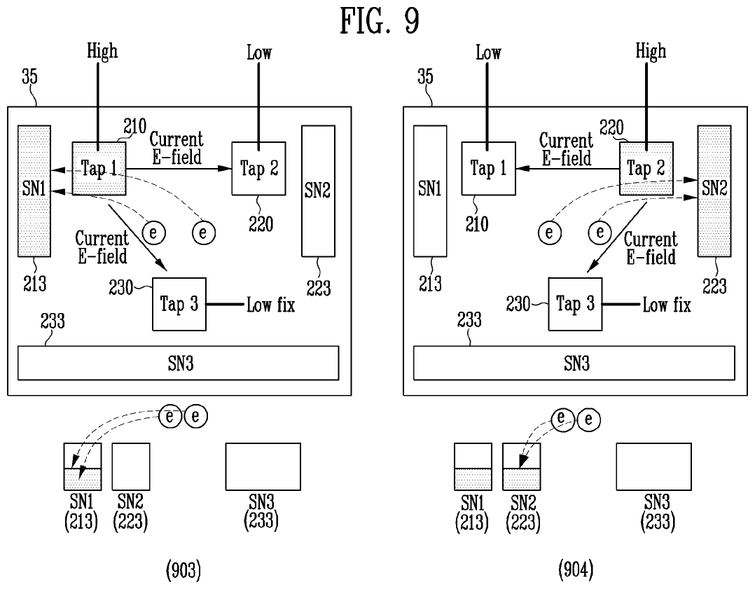

FIG. 8 is a diagram illustrating drive signals applied to taps in a second mode according to an embodiment of the present disclosure. FIG. 9 is a diagram illustrating movements of photocharges in a unit pixel driven in a second mode according to an embodiment of the present disclosure. In FIG. 9, e may represent photocharge. As described above, the second mode may refer to a drive mode of the image sensor when the electronic device 100 is in dark surroundings. The dark surroundings may mean an environment in which light incident on the electronic device is less than the threshold value. For example, the dark surroundings may indicate that there is little or no light incident on the electronic device.

Referring to FIG. 8, the electronic device 100 may apply a first drive signal 810 to the first tap 210, may apply a second drive signal 820 to the second tap 220, and may apply a third drive signal 830 to the third tap 230 by the control circuit. In the present disclosure, the first drive signal 810, the second drive signal 820, and the third drive signal 830 may refer to drive signals which are applied to the first tap 210, the second tap 220, and the third tap 230, respectively.

In the second mode, the first drive signal 810 may correspond to a first modulation voltage which has a first phase, and the second drive signal 820 may be a second modulation voltage which has a second phase. The first and second phases may have a phase difference of 180 degrees with respect to each other. In the second mode, the third drive signal 830 may have the deactivation voltage L. The third drive signal 830 may correspond to a ground voltage.

In the first phase, the activation voltage H and the deactivation voltage L may be repeated at a specified cycle. For example, the first modulation voltage which has the first phase may have the activation voltage H during a first interval 801 and a third interval 803 and may have the deactivation voltage L during a second interval 802 and a fourth interval 804. The above specified cycle may correspond to a time interval obtained by adding the first interval 801 and the second interval 802, i.e., a time interval from a time t1 to a time t3. In the present disclosure, the phase of the first modulation voltage may be referred to as the first phase.

The second phase may have a phase difference of 180 degrees with respect to the first phase. For example, the second modulation voltage which has the second phase may have the deactivation voltage L during the first interval 801 and the third interval 803 and may have the activation voltage H during the second interval 802 and the fourth interval 804. In the present disclosure, the phase of the second modulation voltage may be referred to as the second phase.

In the second mode, the first drive signal 810 applied to the first tap 210 may be the first modulation voltage which has the first phase, and the second drive signal 820 applied to the second tap 220 may be the second modulation voltage which has the second phase. In addition, in the second mode, the third drive signal 830 applied to the third tap 230 may have a specified voltage value (e.g., the deactivation voltage L) which is not the modulation voltage.

Referring to FIGS. 8 and 9, reference numerals 903 of FIG. 9 show photocharges which are moved within the unit pixel 35 at a third time 853, and reference numerals 904 of FIG. 9 may show photocharges which are moved within the unit pixel 35 at a second time 854 of FIG. 8. Referring to FIG. 8, the third time 853 may refer to an arbitrary time at which the first drive signal 810 has the activation voltage H, and the second drive signal 820 has the deactivation voltage L. In addition, the fourth time 854 may refer to an arbitrary time at which the first drive signal 810 has the deactivation voltage L, and the second drive signal 820 has the activation voltage H. At the third time 853 and the fourth time 854, the third drive signal 830 may have a deactivation voltage.

Referring to FIG. 9, as shown by reference numerals 903 corresponding to the third time 853, the activation voltage may be applied to the first tap 210, and the deactivation voltage may be applied to the second tap 220. The deactivation voltage may be applied to the third tap 230.

A pixel current may be generated in the unit pixel 35 by the voltages which are applied to the first tap 210, the second tap 220, and the third tap 230. As shown by reference numerals 903, the pixel current may be generated in a direction from the first tap 210 toward the third tap 230, and a direction from the first tap 210 toward the second tap 220.

The photocharges may be moved by the pixel current which is generated in the substrate of the unit pixel 35. The photocharges which are generated in the unit pixel 35 by reflected light (or incident light) may be moved by the pixel current. As shown by reference numerals 903, the photocharges may be moved in the direction toward the first tap 210 by the pixel current which is generated in the direction from the first tap 210 toward the third tap 230 and the direction from the first tap 210 toward the second tap 220. The photocharges may be captured by the first tap 210. The photocharges captured by the first tap 210 may be stored in the first storage node 213.

Referring to FIG. 9, as shown by reference numerals 904 corresponding to the fourth time 854, the deactivation voltage may be applied to the first tap 210, and the activation voltage may be applied to the second tap 220. The deactivation voltage may be applied to the third tap 230.

A pixel current may be generated in the unit pixel 35 by the voltages which are applied to the first tap 210, the second tap 220, and the third tap 230. As shown by reference numerals 904, the pixel current may be generated in a direction from the second tap 220 toward the first tap 210, and a direction from the second tap 220 toward the third tap 230.

The photocharges may be moved by the pixel current which is generated in the substrate of the unit pixel 35. The photocharges which are generated in the unit pixel 35 by reflected light (or incident light) may be moved by the pixel current. As shown by reference numerals 904, the photocharges may be moved in the direction toward the second tap 220 by the pixel current which is generated in the direction from the second tap 220 toward the first tap 210 and the direction from the second tap 220 toward the third tap 230. The photocharges may be captured by the second tap 220. The photocharges captured by the second tap 220 may be stored in the second storage node 223.

According to the present disclosure, the capacity of the first tap 210 may correspond to that of the second tap 220. For example, the capacity of the first storage node 213 may correspond to that of the second storage node 223. Therefore, the capacity of the tap which captures and stores the photocharges as shown by reference numerals 903 may be substantially the same as the capacity of the tap which captures and stores the photocharges as shown by reference numerals 904.

Referring to FIGS. 7 and 9, the electronic device 100 may increase full well capacity of the image sensor by controlling the image sensor in the first mode in an environment with much light. When the electronic device 100 drives the image sensor in the first mode, the full well capacity of the unit pixel 35 may correspond to the sum of the capacities of the first tap 210, the second tap 220, and the third tap 230. As a result, the full well capacity of the unit pixel 35 may be increased. In an embodiment, when the full well capacity of the unit pixel 35 is increased, the image sensor might not be saturated even when there is a lot of ambient light, not reflected light of modulated light. Accordingly, in an embodiment, distance measurement performance may be improved.

Referring to FIGS. 7 and 9, in an embodiment, the electronic device 100 may reduce full well capacity of the image sensor by controlling the image sensor in the second mode in an environment with less light. When the electronic device 100 drives the image sensor in the second mode, the full well capacity of the unit pixel 35 may correspond to the sum of the capacities of the first tap 210 and the second tap 220. As a result, the full well capacity of the unit pixel 35 in the second mode may be reduced in comparison with the first mode. For example, the full well capacity of the unit pixel 35 which is driven in the second mode may be reduced by half of that of the unit pixel which is driven in the first mode. In an embodiment, when the full well capacity of the unit pixel 35 is reduced, a conversion gain may be increased to reduce noise, so that distance measurement performance of the image sensor may be improved.

Therefore, in an embodiment, the electronic device 100 may provide flexibility with the full well capacity of the unit pixel 35 by selectively driving the image sensor (or the unit pixel 35) in one of the first mode and the second mode according to the brightness of the surroundings. According to an embodiment of the present disclosure, by overcoming the limitations imposed by ambient light, the electronic device 100 may be used regardless of the time (day/night) or place (indoor/outdoor). Therefore, the distance measurement performance of the image sensor according to an embodiment of the present disclosure may be improved, and utilization of the electronic device 100 may be improved.

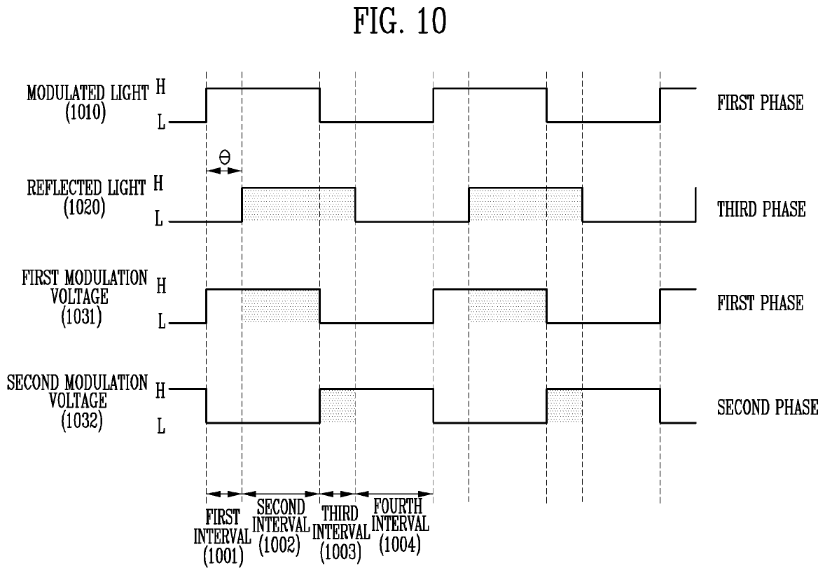

FIG. 10 is a diagram illustrating a method of measuring a distance from an external object by a distance measuring module according to an embodiment of the present disclosure.

Modulated light 1010 may refer to light which is emitted to the external object 1 by the light source 10 which is controlled by the control block 40. The modulated light 1010 may be generated to have an interval having a high level (i.e., the interval at which light is emitted) and an interval having a low level (i.e., the interval at which light is not emitted). The modulated light 1010 may be light which is modulated such that the high level and the low level are repeated at a specified cycle. A phase of the modulated light 1010 may correspond to a first phase.

The reflected light 1020 may refer to light when the modulated light 1010 output from the light source 10 is reflected by the external object 1. A phase difference θ of the reflected light 1020 may vary depending on the distance between the electronic device 100 and the external object 1. In FIG. 10, the phase of the reflected light 1020 may be referred to as a third phase.

Each of the levels of the modulated light 1010 and the reflected light 1020 as shown in FIG. 10 may represent intensity of light. For example, ‘H’ may mean high-intensity light and ‘L’ may mean low-intensity light.

The photoelectric conversion regions 200 and 300 which are included in the unit pixel 35 may generate photocharges in the substrate from the reflected light 1020 (or incident light). As the unit pixel 35 is made incident on the reflected light 1020, photocharges may be generated in the substrate of the unit pixel 35.

When the photocharges are generated in the unit pixel 35 by the reflected light 1020, the control circuit may apply a first drive signal, a second drive signal, and a third drive signal to the first tap 210, the second tap 220, and the third tap 230, respectively. In the first mode, the first drive signal and the second drive signal may correspond to a first modulation voltage 1031, and the third drive signal may correspond to a second modulation voltage 1032. In the second mode, the first drive signal may correspond to the first modulation voltage 1031, and the second drive signal may correspond to the second modulation voltage 1032. The first modulation voltage 1031 may be modulated to have a first phase. The second modulation voltage 1032 may be modulated to have a second phase which has a phase difference of 180 degrees with respect to the first phase. According to the present disclosure, the first phase of the first modulation voltage 1031 may be substantially the same as the first phase of the modulated light 1010.

The first modulation voltage 1031 may be modulated to have an activation voltage (a high level) during a first interval 1001 and a second interval 1002 and a deactivation voltage (a low level) during a third interval 1003 and a fourth interval 1004. The second modulation voltage 1032 may be modulated to have a deactivation voltage (a low level) during a first interval 1001 and a second interval 1002 and an activation voltage (a high level) during a third interval 1003 and a fourth interval 1004.

Referring to FIGS. 7 and 9, a tap (210, 220, or 230) included in the unit pixel 35 may capture photocharges corresponding to the reflected light 1020 which is incident at a time when the drive signal applied to the corresponding tap has the activation voltage (a high level). For example, when a tap to which the first modulation voltage 1031 is applied (e.g., the first and second taps 210 and 220 in the first mode and the first tap 210 in the second mode) may capture photocharges by the reflected light 1020 during the second interval 1002. In addition, a tap to which the second modulation voltage 1032 is applied (e.g., the third tap 230 in the first mode and the second tap 220 in the second mode) may capture photocharges by the reflected light 1020 during the third interval 1003.

The readout circuit 45 may obtain pixel data corresponding to the photocharges captured by each of the taps 210, 220, and 230 by reading out the taps 210, 220, and 230 included in the unit pixel 35. The distance measuring module 50 may identify a third phase of the reflected light 1020 on the basis of the pixel data. The distance measuring module 50 may identify the distance from the external object 1 (or the depth of the external object 1) on the basis of the phase difference θ between the first phase of the modulated light 1010 and the third phase of the reflected light 1020.

For example, in the first mode, the readout circuit 45 may obtain first pixel data corresponding to the photocharges captured at least during the second interval 1002 by reading out the tap to which the first modulation voltage 1031 is applied (e.g., the first tap 210 and the second tap 220). In addition, the readout circuit 45 may obtain second pixel data corresponding to the photocharges captured at least during the third interval 1003 by reading out the tap to which the second modulation voltage 1032 is applied (e.g., the third tap 230). The distance measuring module 50 may receive the first pixel data and the second pixel data from the readout circuit 45. The distance measuring module 50 may identify a third phase of the reflected light 1020 on the basis of the first pixel data and the second pixel data. The distance measuring module 50 may identify the distance from the external object 1 on the basis of the phase difference θ between the first phase of the modulated light 1010 and the third phase of the reflected light 1020.

In another example, in the second mode, the readout circuit 45 may obtain third pixel data corresponding to the photocharges captured at least during the second interval 1002 by reading out the tap to which the first modulation voltage 1031 is applied (e.g., the first tap 210). In addition, the readout circuit 45 may obtain fourth pixel data corresponding to the photocharges captured at least during the third interval 1003 by reading out the tap to which the second modulation voltage 1032 is applied (e.g., the second tap 220). The distance measuring module 50 may receive the third pixel data and the fourth pixel data from the readout circuit 45. The distance measuring module 50 may identify a third phase of the reflected light 1020 on the basis of the third pixel data and the fourth pixel data. The distance measuring module 50 may identify the distance from the external object 1 on the basis of the phase difference θ between the first phase of the modulated light 1010 and the third phase of the reflected light 1020.

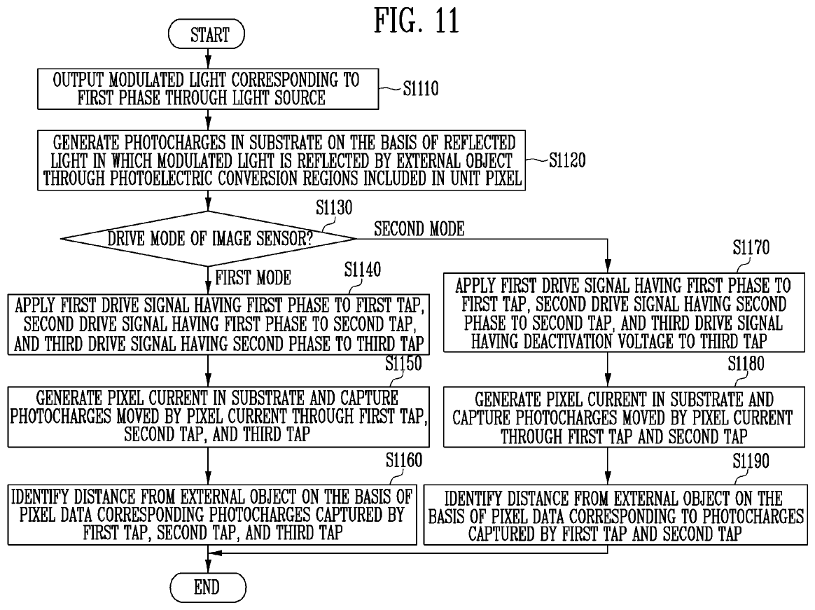

FIG. 11 is a flow chart illustrating a method of identifying a distance from an external object on the basis of drive signals applied to three taps, respectively, by the electronic device 100.

At step S1110, the electronic device 100 may output the modulated light 1010 corresponding to the first phase through the light source 10.

At step S1120, the electronic device 100 may generate photocharges in the substrate on the basis of the reflected light 1020 where the modulated light 1010 is reflected by the external object 1 through the photoelectric conversion regions 200 and 300 included in the unit pixel 35.

At step S1130, the electronic device 100 may operate differently according to whether a drive mode of an image sensor is a first mode or a second mode. For example, the electronic device 100 may determine ambient brightness and drive the image sensor in the first mode in response to the brightness which is equal to or greater than a specified value, or in the second mode in response to the brightness which is less than the specified value. For example, the electronic device 100 may determine the brightness using an auto exposure (AE) function. In another example, the electronic device 100 may determine the brightness using a separate light sensor. As shown in the flowchart of FIG. 11, the drive mode of the image sensor may be identified after step S1120. However, during the actual operations of the electronic device 100, it may be understood that step S1130 is performed prior to step S1120, and step S1120 is performed at the same time as steps S1140 and S1150, or steps S1170 and S1180.

At step S1140, the electronic device 100 in the first mode may apply the first drive signal 610 having the first phase to the first tap 210, the second drive signal 620 having the first phase to the second tap 220, and the third drive signal 630 having the second phase to the third tap 230.

At step S1150, the electronic device 100 in the first mode may generate a pixel current in the substrate through step S1140 and capture the photocharges, which are moved by the pixel current, through the first tap 210, the second tap 220, and the third tap 230. For example, at the first time 651 when the first drive signal 610 and the second drive signal 620 have the activation voltage (a high level) and the third drive signal 630 has the deactivation voltage (a low level), the photocharges may be captured by the first tap 210 and the second tap 220. In addition, at the second time 652 when the first drive signal 610 and the second drive signal 620 have the deactivation voltage (a low level) and the third drive signal 630 has the activation voltage (a high level), the photocharges may be captured by the third tap 230.

At step S1160, the electronic device 100 in the first mode may identify the distance from the external object 1 on the basis of the pixel data corresponding to the photocharges captured through the first tap 210, the second tap 220, and the third tap 230.

At step S1170, the electronic device 100 in the second mode may apply the first drive signal 810 having the first phase to the first tap 210, the second drive signal 820 having the second phase to the second tap 220, and the third drive signal 830 having the deactivation voltage (a low level) to the third tap 230.

At step S1180, the electronic device 100 in the second mode may generate a pixel current in the substrate through step S1170 and capture the photocharges, which are moved by the pixel current, through the first tap 210 and the second tap 220. For example, at the third time 853 when the first drive signal 810 has the activation voltage (a high level) and the second and third drive signals 820 and 830 have the deactivation voltage (a low level), the photocharges may be captured by the first tap 210. In addition, at the second time 854 when the first drive signal 810 and the third drive signal 830 have the deactivation voltage (a low level) and the second drive signal 820 has the activation voltage (a high level), the photocharges may be captured by the second tap 220.

At step S1190, the electronic device 100 in the second mode may identify the distance from the external object 1 on the basis of the pixel data corresponding to the photocharges captured through the first tap 210 and the second tap 220.

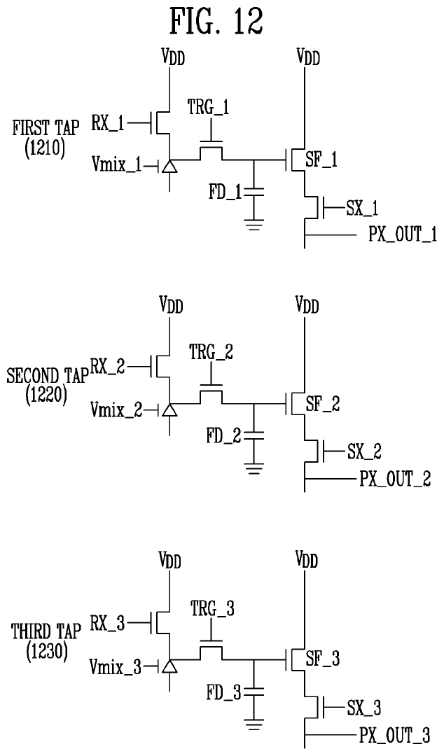

FIG. 12 is a diagram illustrating an example of circuit configurations of first, second, and third taps according to an embodiment of the present disclosure. A first tap 1210, a second tap 1220, and a third tap 1230 as shown in FIG. 12 may correspond to the first tap 210, the second tap 220, and the third tap 230, respectively, as shown in FIGS. 2 to 11. The number ‘2’ for the elements of the second tap 1220 will be used to indicate the similar corresponding elements with the number ‘1’ in the first tap 1210. For example, reset transistor RX_1 is the reset transistor for the first trap 1210 and the reset transistor for the second tap 1220 is RX_2. The number ‘3’ for the elements of the third tap 1230 will be used to indicate the similar corresponding elements with the number ‘1’ in the first tap 1210. For example, reset transistor RX_1 is the reset transistor for the first trap 1210 and the reset transistor for the third tap 1230 is RX_3.

The first tap 1210 may include a reset transistor RX_1, a transfer gate TRG_1, a floating diffusion FD_1, a source follower SF_1, a select transistor SX_1, and a pixel signal output line PX_OUT_1. The control circuit may apply a first drive signal Vₘᵢₓ_1 to the first tap 1210. Photocharges which are generated in a photodiode or a substrate may be captured by the first tap 1210 when the first drive signal Vₘᵢₓ_1 is at a high level. The captured photocharges may be stored in the floating diffusion FD_1 when the transfer gate TRG_1 of the first tap 1210 is activated. The photocharges stored in the floating diffusion FD_1 may be converted into an electric signal through the source follower SF_1. The control circuit may select the unit pixel 35 (or the first tap 1210 included in the unit pixel 35) which is to be read out by the select transistor SX_1. A pixel signal corresponding to the photocharges captured by the first tap 1210 when the select transistor SX_1 is activated may be output to the readout circuit 45 through the pixel signal output line PX_OUT_1. The pixel signal output line PX_OUT_1 may correspond to the column line as shown in FIG. 5. By activating the reset transistor RX_1, the control circuit may reset a photoelectric conversion region (e.g., the substrate or the photodiode) and may also reset the floating diffusion FD_1. The description about the components, such as the transistor, included in the first tap 1210 may be applicable to the second tap 1220 and the third tap 1230.

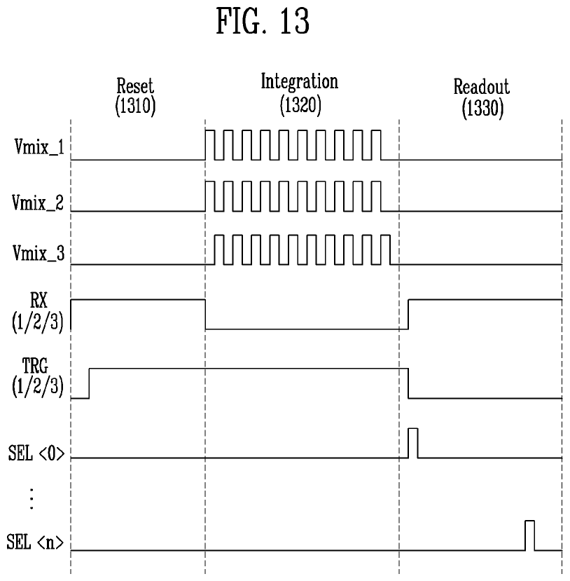

FIG. 13 is a diagram illustrating an example of signals provided to a unit pixel in a first mode according to an embodiment of the present disclosure.

Referring to FIG. 13, in a first mode, the control circuit may measure a depth of the external object 1 by a ToF technique by providing various signals to the first tap 1210, the second tap 1220, and the third tap 1230. The measurement of the depth using the ToF technique may be performed in a reset period 1310, an integration period 1320, and a readout period 1330.

In the reset period 1310, the control circuit may reset the photoelectric conversion regions 200 and 300 by activating the reset transistor RX_1 of the first tap 1210, a reset resistor RX_2 of the second tap 1220, and a reset transistor RX_3 of the third tap 1230. In addition, in the reset period 1310, the control circuit may reset the floating diffusions FD_1, FD_2, and FD_3 by activating the transfer gate TRG_1 of the first tap 1210, a transfer gate TRG_2 of the second tap 1220, and a transfer gate TRG_3 of the third tap 1230.

In the integration period 1320, the electronic device 100 may output modulated light through the light source 10, and the control circuit may expose the unit pixels 35 included in the pixel array 30. For example, the control circuit may expose all unit pixels 35 included in the pixel array 30 in a similar manner to a global shutter operation.

In the integration period 1320, the control circuit in the first mode may apply the first drive signal Vₘᵢₓ_1 having the first phase to the first tap 1210, a second drive signal Vₘᵢₓ_2 having the first phase to the second tap 1220, and a third drive signal Vₘᵢₓ_3 having the second phase to the third tap 1230.

In the integration period 1320, since the transfer gates TRG_1, TRG_2, and TRG_3 are activated, the photocharges captured by the taps 1210, 1220, and 1230 may be stored in the floating diffusions FD_1, FD_2, and FD_3.

In the readout period 1330, the control circuit may activate the reset transistors RX_1, RX_2, and RX_3 and may deactivate the transfer gates TRG_1, TRG_2, and TRG_3. In addition, the control circuit may activate the select transistors SX_1, SX_2, and SX_3 through row select signals SEL <0> to SEL <n>. The readout circuit 45 may sequentially read out the unit pixels 35 included in the pixel array 30 according to rows.

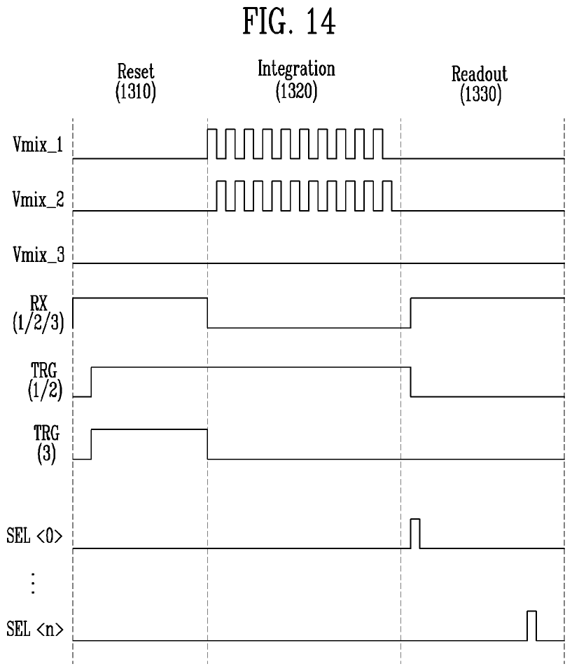

FIG. 14 is a diagram illustrating an example of signals provided to a unit pixel in a second mode according to an embodiment of the present disclosure.

Referring to FIG. 14, in a second mode, the control circuit may measure a depth of the external object 1 by a ToF technique by providing various signals to the first tap 1210, the second tap 1220, and the third tap 1230. Parts of FIG. 14 which overlap those of FIG. 13 may be briefly described or might not be described. FIG. 14 is different from FIG. 13 in terms of the third drive signal Vₘᵢₓ_3 applied to the third tap 1230 and the period in which the transfer gate TRG_3 of the third tap 230 is activated. Thus, the features of the second mode which are differentiated from those of the first mode will be described with reference to FIG. 14.

In the integration period 1320, the control circuit in the second mode may apply the third drive signal Vₘᵢₓ_3 having the deactivation voltage (a low level) to the third tap 1230. Therefore, there may be few or no photocharges captured by the third tap 1230. Since few or no photocharges are to be stored in the floating diffusion FD_3 of the third tap 1230, the control circuit might not activate the transfer gate TRG_3 of the third tap 1230 during the integration period 1320.

During the readout period 1330, the electronic device 100 in the second mode might not read out the third tap 1230. In the second mode, the readout circuit 45 may read out the first tap 1210 and the second tap 1220 of the unit pixel 35 corresponding to the row select signals SEL <0> to SEL <n>.

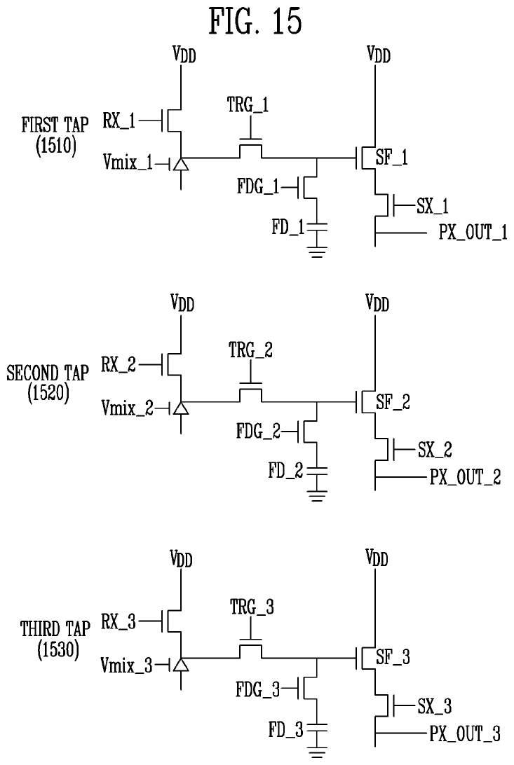

FIG. 15 is a diagram illustrating another example of circuit configurations of first, second, and third taps according to an embodiment of the present disclosure. A first tap 1510, a second tap 1520, and a third tap 1530 as shown in FIG. 15 may correspond to the first tap 210, the second tap 220, and the third tap 230, respectively, as shown in FIGS. 2 to 11. The number ‘2’ for the elements of the second tap 1520 will be used to indicate the similar corresponding elements with the number ‘1’ in the first tap 1510. For example, reset transistor RX_1 is the reset transistor for the first trap 1510 and the reset transistor for the second tap 1520 is RX_2. The number ‘3’ for the elements of the third tap 1530 will be used to indicate the similar corresponding elements with the number ‘1’ in the first tap 1510. For example, reset transistor RX_1 is the reset transistor for the first trap 1510 and the reset transistor for the third tap 1530 is RX_3.

The first tap 1510, the second tap 1520, and the third tap 1530 as shown in FIG. 15 may further include floating diffusion transistors FDG_1, FDG_2, and FDG_3, respectively, in comparison with the first tap 1210, the second tap 1220, and the third tap 1230. The other components of FIG. 15 may correspond to those of FIG. 12. For example, the first tap 1510 may further include the floating diffusion transistor FDG_1 in addition to the reset transistor RX_1, the transfer gate TRG_1, the floating diffusion FD_1, the source follower SF_1, the select transistor SX_1, and the pixel signal output line PX_OUT_1. Some of the components as shown in FIG. 15 which are described above with reference to FIG. 12 may be briefly described or might not be described.

The control circuit may control the capacity of the first tap 1510 by using the floating diffusion transistor FDG_1. For example, the control circuit may separate a capacitor of the floating diffusion FD_1 from an FD node by deactivating the floating diffusion transistor FDG_1. When the control circuit deactivates the floating diffusion transistor FDG_1, the capacity of the first tap 1510 may correspond to the capacity of the FD node. In another example, the control circuit may activate the floating diffusion transistor FDG_1 and connect the capacitor of the floating diffusion FD_1 to the FD node. When the control circuit activates the floating diffusion transistor FDG_1, the capacity of the first tap 1510 may be increased by the capacity of the capacitor.

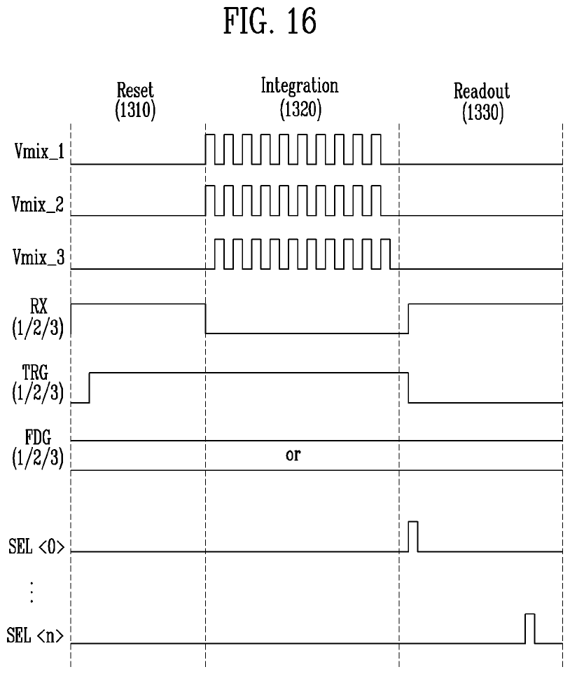

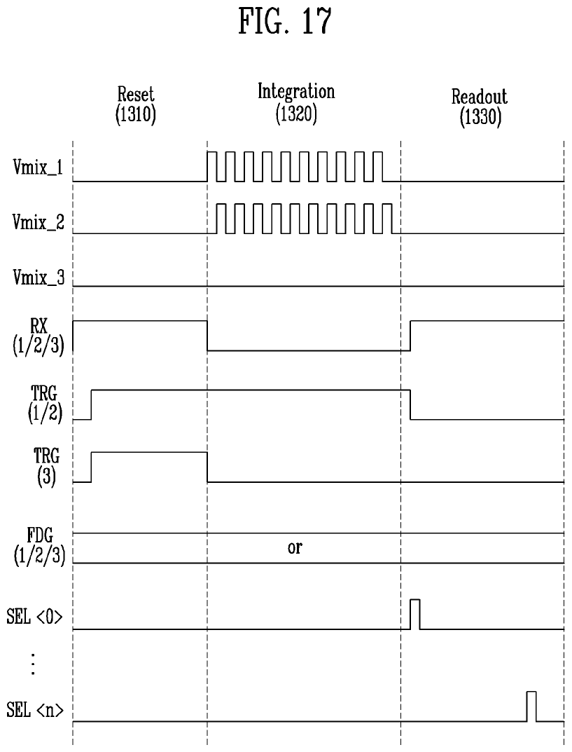

FIG. 16 is a diagram illustrating another example of signals provided to a unit pixel in a first mode according to an embodiment of the present disclosure. FIG. 17 is a diagram illustrating another example of signals provided to a unit pixel in a second mode according to an embodiment of the present disclosure.

In comparison with FIG. 13, FIG. 16 may further show signals which are applied to the floating diffusion transistors FDG_1, FDG_2, and FDG_3 by the control circuit. In comparison with FIG. 14, FIG. 17 may further show signals which are applied to the floating diffusion transistors FDG_1, FDG_2, and FDG_3 by the control circuit. Duplicate descriptions of the components described above with reference to FIGS. 13 and 14 may be briefly described or might not be described with reference to FIGS. 16 and 17.

Referring to FIGS. 16 and 17, the control circuit may apply an activation voltage (a high level) or a deactivation voltage (a low level) to the floating diffusion transistors FDG_1, FDG_2, and FDG_3. The control circuit may apply the activation voltage or the deactivation voltage to all of the floating diffusion transistors FDG_1, FDG_2, and FDG_3 included in the unit pixel 35. The capacity of the taps 1510, 1520, and 1530 may be increased when the control circuit applies the high level to the floating diffusion transistors FDG_1, FDG_2, and FDG_3. In addition, the capacity of the taps 1510, 1520, and 1530 may be decreased when the control circuit applies the low level to the floating diffusion transistors FDG_1, FDG_2, and FDG_3.

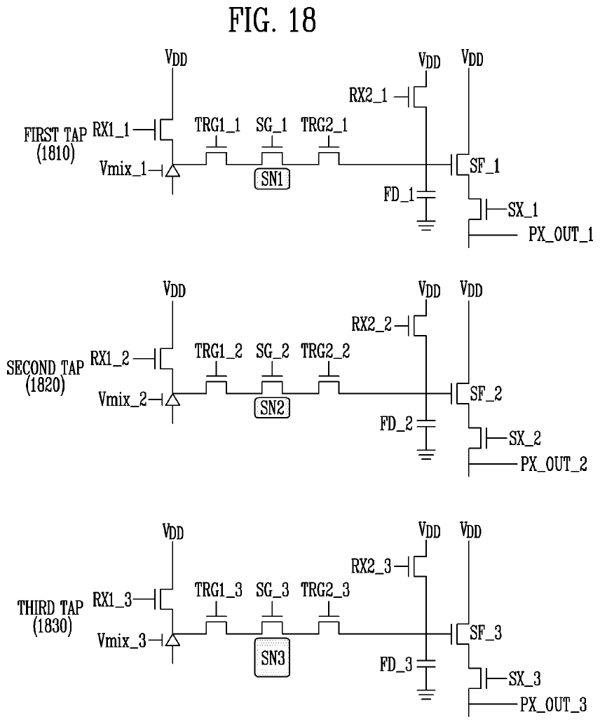

FIG. 18 is a diagram illustrating another example of circuit configurations of first, second, and third taps according to an embodiment of the present disclosure. A first tap 1810, a second tap 1820, and a third tap 1830 as shown in FIG. 18 may correspond to the first tap 210, the second tap 220, and the third tap 230, respectively, as shown in FIGS. 2 to 11. The number ‘2’ for the elements of the second tap 1820 will be used to indicate the similar corresponding elements with the number ‘1’ in the first tap 1810. For example, reset transistor RX_1 is the reset transistor for the first trap 1810 and the reset transistor for the second tap 1820 is RX_2. The number ‘3’ for the elements of the third tap 1830 will be used to indicate the similar corresponding elements with the number ‘1’ in the first tap 1810. For example, reset transistor RX_1 is the reset transistor for the first trap 1810 and the reset transistor for the third tap 1830 is RX_3.

Referring to FIG. 18, the first tap 1810 may include a first reset transistor RX1_1, a first transfer gate TRG1_1, a storage node transistor SG_1, a second transfer gate TRG2_1, the floating diffusion FD_1, a second reset transistor RX2_1, the source follower SF_1, the select transistor SX_1, and the pixel signal output line PX_OUT_1. When the first tap 1810 of FIG. 18 is compared against the first tap 1210 of FIG. 12, one reset transistor and one transfer gate may be further added as a first storage node SN1 is added. The capacity of the first storage node SN1, the capacity of a second storage node SN2 of the second tap 1820, and the capacity of a third storage node SN3 may correspond to 1:1:2.

The control circuit may apply the first drive signal Vₘᵢₓ_1 to the first tap 1810. Photocharges which are generated in a photodiode or a substrate may be captured by the first tap 1810 when the first drive signal Vₘᵢₓ_1 is at a high level. The control circuit may store the captured photocharges in the first storage node SN1 by activating the first transfer gate TRG1_1 and the storage node transistor SG_1 of the first tap 1810. The control circuit may store the photocharges stored in the first storage node SN1 in the floating diffusion FD_1 by activating the second transfer gate TRG2_1. The photocharges stored in the floating diffusion FD_1 may be converted into an electric signal through the source follower SF_1. The control circuit may select the unit pixel 35 (or the first tap 1810 included in the unit pixel 35) which is to be read out by the select transistor SX_1. A pixel signal corresponding to the photocharges captured by the first tap 1810 when the select transistor SX_1 is activated may be output to the readout circuit 45 through the pixel signal output line PX_OUT_1.

The control circuit may reset a photoelectric conversion region (e.g., the substrate or the photodiode) by activating the first reset transistor RX1_1 and may also reset the floating diffusion FD_1 by activating the second reset transistor RX2_1. The description about the composition such as the transistor included in the first tap 1810 may be applicable to the second tap 1820 and the third tap 1830.

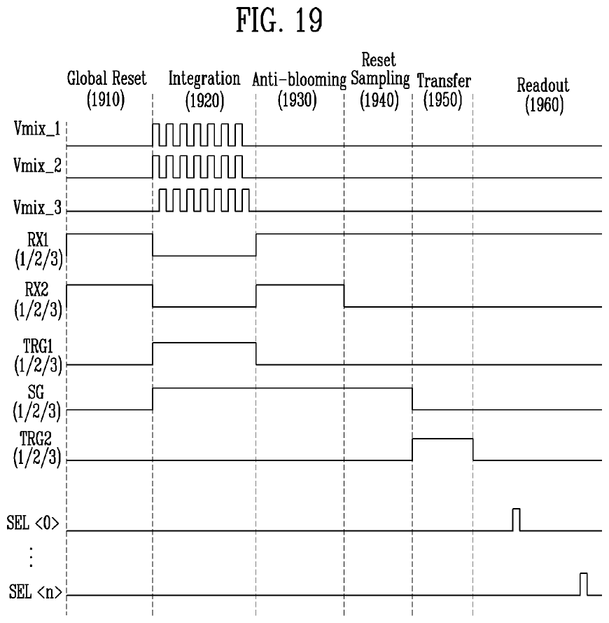

FIG. 19 is a diagram illustrating another example of signals provided to a unit pixel in a first mode according to an embodiment of the present disclosure.

Referring to FIG. 19, in a first mode, the control circuit may measure a depth of the external object 1 by a ToF technique by providing various signals to the first tap 1810, the second tap 1820, and the third tap 1830. The measurement of the depth by the ToF technique may be performed during a global reset period 1910, an integration period 1920, an anti-blooming period 1930, a reset sampling period 1940, a transfer period 1950, and a readout period 1960.

During the global reset period 1910, the control circuit may reset a substrate or a photodiode of each of the taps 1810, 1820, and 1830 by activating each of the first reset transistors RX1_1, RX1_2, and RX1_3, and may reset the floating diffusions FD_1, FD_2, and FD_3 of the taps 1810, 1820, and 1830 by activating the second reset transistors RX2_1, RX2_2, and RX2_3, respectively.

In the integration period 1920, the control circuit in the first mode may apply the first drive signal Vₘᵢₓ_1 having the first phase to the first tap 1810, the second drive signal Vₘᵢₓ_2 having the first phase to the second tap 1820, and the third drive signal Vₘᵢₓ_3 having the second phase to the third tap 1830.

During the integration period 1920, since the first transfer gates TRG1_1, TRG1_2, and TRG1_3 and the storage node transistors SG_1, SG_2, and SG_3 are activated, the photocharges captured by the taps 1810, 1820, and 1830 may be stored in the storage nodes SN1, SN2, and SN3, respectively.

During the anti-blooming period 1930, the control circuit may deactivate the first transfer gates TRG1_1, TRG1_2, and TRG1_3 and the second transfer gates TRG2_1, TRG2_2, and TRG2_3, and may deactivate the first reset transistors RX1_1, RX1_2, and RX1_3 and the second reset transistors RX2_1, RX2_2, and RX2_3. Through the anti-blooming period 1930, the control circuit may prevent or mitigate the photocharges stored in the storage nodes SN1, SN2, and SN3 from overflowing to the floating diffusions FD_1, FD_2, and FD_3.

The control circuit may deactivate the second reset transistors RX2_1, RX2_2, and RX2_3 during the reset sampling period 1940 and may activate the second transfer gates TRG2_1, TRG2_2, and TRG2_3 during the transfer period 1950, thereby transferring the photocharges stored in the storage nodes SN1, SN2, and SN3 to the floating diffusions FD_1, FD_2, and FD_3.

During the readout period 1960, the control circuit may read out the unit pixels 35 of the pixel array 30 on the basis of the row select signals SEL <0> to SEL <n>. For example, in the first mode, the readout circuit 45 may read out each of the first tap 1810, the second tap 1820, and the third tap 1830 of the unit pixel 35.

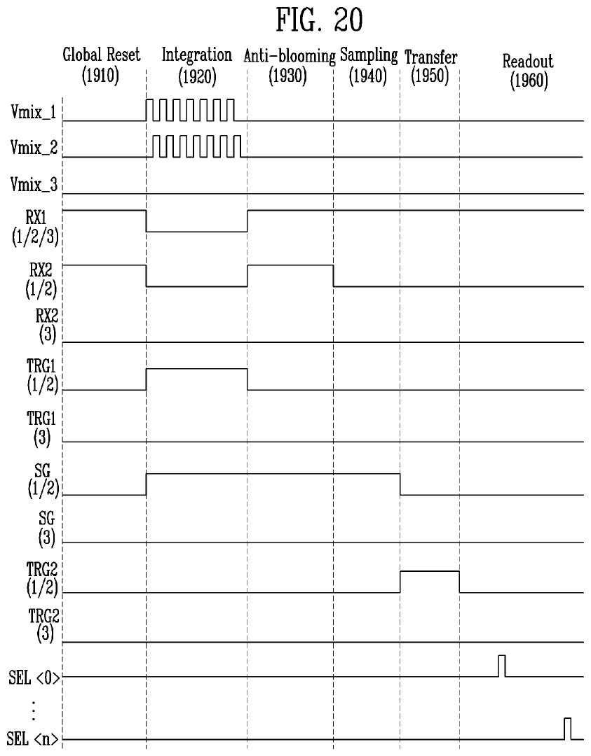

FIG. 20 is a diagram illustrating another example of signals provided to a unit pixel in a second mode according to an embodiment of the present disclosure.

Referring to FIG. 20, in the second mode, the control circuit may measure a depth of the external object 1 by a ToF technique by providing various signals to the first tap 1810, the second tap 1820, and the third tap 1830. Parts of FIG. 20 which overlap those of FIG. 19 may be briefly described or might not be described. FIG. 20 is different from FIG. 19 in terms of the third drive signal Vₘᵢₓ_3 applied to the third tap 1830, and the second reset transistor RX2_3, the first transfer gate TRG1_3, the storage node transistor SG_3, and the second transfer gate TRG2_3 of the third tap 1830 which are deactivated. Therefore, the features of the second mode which are differentiated from those of the first mode will be described below in detail.

In the integration period 1920, the control circuit in the second mode may apply the third drive signal Vₘᵢₓ_3 having the deactivation voltage (a low level) to the third tap 1830. Therefore, there may be few or no photocharges captured by the third tap 1830. Since there are few or no photocharges stored in the third storage node SN3 of the third tap 1830, the control circuit might not activate the second reset transistor RX2_3, the first transfer gate TRG1_3, the storage node transistor SG_3, and the second transfer gate TRG2_3 of the third tap 1830 while being driven in the second mode.

According to an embodiment of the present disclosure, by providing an image sensor which can overcome limitations imposed by ambient light in an environment where a sensing system using a ToF technique is used, the sensing system using the ToF technique may be used regardless of the illuminance of the surrounding environment such as indoors, outdoors, day, and night, so that distance measurement performance using the image sensor may be improved, and utilization of an electronic device using the same may be improved.

It will be apparent to those skilled in the art that various modifications can be made to the above-described examples of embodiments without departing from the spirit or scope of the invention. Thus, it is intended that the present disclosure covers all such modifications provided they come within the scope of the appended claims and their equivalents.

What is claimed is:

1. An image sensor, comprising:
a unit pixel configured to output pixel data in response to a drive signal being input to the unit pixel; and
a control circuit configured to provide the unit pixel with a first drive signal and a second drive signal each having a first phase, and a third drive signal having a second phase with substantially a phase difference of 180 degrees with respect to the first phase in a first mode, the control circuit providing the unit pixel with the first drive signal having the first phase, the second drive signal having the second phase, and the third drive signal having a deactivation voltage in a second mode.

2. The image sensor of claim 1, wherein the unit pixel comprises:
a photoelectric conversion region configured to generate photocharges in a substrate from incident light; and
a first tap, a second tap, and a third tap configured to generate a pixel current in the substrate in response to the first drive signal, the second drive signal, and the third drive signal applied by the control circuit, and capturing the photocharges moved by the pixel current.

3. The image sensor of claim 2, wherein a capacity of the third tap corresponds to a sum of both a capacity of the first tap and a capacity of the second tap.

4. The image sensor of claim 2, wherein the first phase is a phase where an activation voltage and the deactivation voltage are repeated.

5. The image sensor of claim 4, wherein in the first mode:
the photocharges are captured by the first tap and the second tap at a first time when the first drive signal and the second drive signal have the activation voltage, and the third drive signal has the deactivation voltage, and
the photocharges are captured by the third tap at a second time when the first drive signal and the second drive signal have the deactivation voltage, and the third drive signal has the activation voltage.

6. The image sensor of claim 4, wherein in the second mode:
the photocharges are captured by the first tap at a third time when the first drive signal has the activation voltage and the second drive signal has the deactivation voltage, and
the photocharges are captured by the second tap at a fourth time when the first drive signal has the deactivation voltage and the second drive signal has the activation voltage.

7. The image sensor of claim 2, further comprising a readout circuit configured to obtain pixel data corresponding to the photocharges captured by at least part of the first tap, the second tap, and the third tap.

8. The image sensor of claim 1, wherein the first mode and the second mode are determined based on ambient brightness of the image sensor.

9. An electronic device, comprising:
a light source configured to output modulated light corresponding to a first phase;
a unit pixel including a photoelectric conversion region configured to generate photocharges in a substrate from reflected light in which the modulated light is reflected by an external object, and a first tap, a second tap, and a third tap configured to generate a pixel current in the substrate and capture the photocharges moved by the pixel current;
a control circuit configured to control the first to third taps to generate the pixel current by applying a first drive signal, a second drive signal, and a third drive signal to the first tap, the second tap, and the third tap, respectively; and
a distance measuring module configured to identify a distance from the external object on the basis of pixel data corresponding to the photocharges captured and received from at least part of the first tap, the second tap, and the third tap,
wherein in the first mode, each of the first drive signal and the second drive signal has the first phase, and the third drive signal has a second phase with substantially a phase difference of 180 degrees with respect to the first phase, and
in the second mode, the first drive signal has the first phase, the second drive signal has the second phase, and the third drive signal has a deactivation voltage.

10. The electronic device of claim 9, wherein a capacity of the third tap corresponds to a sum of both a capacity of the first tap and a capacity of the second tap.

11. The electronic device of claim 9, wherein the first phase is a phase where an activation voltage and the deactivation voltage are repeated at a specified cycle.

12. The electronic device of claim 11, wherein in the first mode:
the photocharges are captured by the first tap and the second tap at a first time when the first drive signal and the second drive signal have the activation voltage, and the third drive signal has the deactivation voltage, and
the photocharges are captured by the third tap at a second time when the first drive signal and the second drive signal have the deactivation voltage, and the third drive signal has the activation voltage.

13. The electronic device of claim 11, wherein in the second mode:
the photocharges are captured by the first tap at a third time when the first drive signal has the activation voltage and the second drive signal has the deactivation voltage, and
the photocharges are captured by the second tap at a fourth time when the first drive signal has the deactivation voltage and the second drive signal has the activation voltage.

14. The electronic device of claim 9, further comprising a processor configured to control the control circuit to apply the first drive signal, the second drive signal, and the third drive signal according to one of the first mode and the second mode on the basis of ambient brightness of the electronic device.

15. The electronic device of claim 9, wherein the distance measuring module identifies a third phase corresponding to the reflected light on the basis of the pixel data, and identifies the distance from the external object on the basis of a phase difference between the first phase and the third phase.

16. The electronic device of claim 15, wherein the distance measuring module identifies the phase difference on the basis of first pixel data corresponding to photocharges captured by the first tap and the second tap and second pixel data corresponding to photocharges captured by the third tap in the first mode, and identifies the phase difference on the basis of third pixel data corresponding to photocharges captured by the first tap and fourth pixel data corresponding to photocharges captured by the second tap in the second mode.

17. A method of operating an electronic device, the method comprising:
outputting modulated light corresponding to a first phase through a light source;
generating photocharges in a substrate on the basis of reflected light in which the modulated light is reflected by an external object through a photoelectric conversion region included in a unit pixel;
generating a pixel current in the substrate and capturing the photocharges moved by the pixel current through at least one of a first tap, a second tap, and a third tap included in the unit pixel by applying a first drive signal, a second drive signal, and a third drive signal to the first tap, the second tap, and the third tap, respectively, according to one of a first mode and a second mode; and
identifying a distance from the external object on the basis of pixel data corresponding to the photocharges captured by the at least one of the first tap, the second tap, and the third tap,
wherein in the first mode, each of the first drive signal and the second drive signal has the first phase, and the third drive signal has a second phase with substantially a phase difference of 180 degrees with respect to the first phase, and
in the second mode, the first drive signal has the first phase, the second drive signal has the second phase, and the third drive signal has a deactivation voltage.

18. The method of claim 17, further comprising:
determining brightness of surroundings of the electronic device;
applying the first drive signal, the second drive signal, and the third drive signal to the first tap, the second tap, and the third tap, respectively, according to the first mode in response to the brightness being equal to or greater than a specified value; and
applying the first drive signal, the second drive signal, and the third drive signal to the first tap, the second tap, and the third tap, respectively, according to the second mode in response to the brightness being less than the specified value.

19. The method of claim 17, wherein the capturing the photocharges by applying the first drive signal, the second drive signal, and the third drive signal to the first tap, the second tap, and the third tap, respectively, according to the first mode comprises:
capturing the photocharges by the first tap and the second tap at a first time when the first drive signal and the second drive signal have an activation voltage and the third drive signal has the deactivation voltage; and
capturing the photocharges by the third tap at a second time when the first drive signal and the second drive signal have the deactivation voltage, and the third drive signal has the activation voltage.

20. The method of claim 17, wherein the capturing the photocharges by applying the first drive signal, the second drive signal, and the third drive signal to the first tap, the second tap, and the third tap, respectively, according to the second mode comprises:
capturing the photocharges by the first tap at a third time when the first drive signal has an activation voltage, and each of the second drive signal and the third drive signal has the deactivation voltage; and
capturing the photocharges by the second tap at a fourth time when the first drive signal and the third drive signal have the deactivation voltage, and the second drive signal has the activation voltage.

21. The method of claim 17, wherein the identifying the distance from the external object on the basis of the pixel data comprises:
identifying a third phase corresponding to the reflected light on the basis of the pixel data; and
identifying the distance from the external object on the basis of a phase difference between the first phase and the third phase.
